(19) United States
(12) Patent Application Publication
(10) Pub. No.: US 2015/0266908 A1
(43) Pub. Date: Sep. 24, 2015

(54) FLAME RETARDANT COMPRISING AROMATIC PHOSPHATE ESTER-BASED COMPOUND, AND METHOD FOR PREPARING SAME

(71) Applicant: Seung Min KWAK, (US)

(72) Inventor: Seung Min Kwak, Daegu (KR)

(21) Appl. No.: 14/431,353

(22) PCT Filed: Sep. 24, 2013
(86) PCT No.: PCT/KR2013/008541

§ 371 Date: Mar. 26, 2015

(30) Foreign Application Priority Data
Sep. 26, 2012 (KR) 10-2012-0107310
Sep. 26, 2012 (KR) 10-2012-0107311

(51) Int. Cl. C07F 9/24; B01D 3/10; B01J 19/00; B01D 3/32; B01J 19/24; B01J 19/18; B01D 3/14; B01D 19/00

(52) U.S. Cl. CPC C07F 9/2458; B01D 3/143; B01D 3/106; B01D 19/0036; B01D 3/32; B01J 19/24; B01J 19/18; B01J 19/0066; B01J 2219/0011; B01J 2219/24; B01J 2219/00761

(57) ABSTRACT

A method for preparing a novel aromatic phosphate ester-based compound, including: (a) reacting a compound expressed by chemical formula 1 (i) and a C₆₋₁₀ aryl compound substituted with hydroxy or C₁₋₆ alkoxy, or a C₆₋₂₀ arylalkyl compound substituted with hydroxy or C₁₋₆ alkoxy (ii), which are used as reaction materials by gradually heating to the temperature levels of 90-125° C., 125-180° C., 180-210° C. and 210-240° C.; (b) separating an aromatic phosphate ester-based compound from the resultant product in step (a) under the condition of a pressure of 0.01 mmHg-50 mmHg and a temperature of 50° C.-300° C. using fractional distillation; and (c) reacting the aromatic phosphate ester-based compound separated in step (b) (i) and C₁₋₁₀ alcohol or a nitrogen compound (ii) at a temperature of 10-70° C.

### TECHNICAL FIELD

This application claims priority to and the benefit of Korean Patent Application No. 10-2012-0107310 and 10-2012-0107311 filed in the Korean Intellectual Property Office on Sep. 26, 2012, the entire contents of which are incorporated herein by reference.

The present invention relates to a flame retardant comprising aromatic phosphate ester-based compound and method for preparing the same.

### BACKGROUND ART

Thermoplastics like polypropylene, polystyrene, polyester, etc. and thermosetting plastics like polyurethane or phenol can be manufactured with the relatively lower price, and have the excellent property to be easily formed. Accordingly, these plastics are widely used for overall daily supplies including electronic components and automobile components.

Nonetheless, these thermoplastics and thermosetting plastics have shortcomings to be easily combusted or destroyed when the outbreak of fire. Especially, fire in a public establishment like electric installation and communication cable may cause huge damage to the social function. In order to improve these shortcomings, flame proofing is defined by law in some fields like electric applications, internals of automobile and textile goods which use the plastics.

Generally, flame retardants is added when manufacturing the plastic goods in order to add flame proofing to the plastics, and inorganic compounds, organic phosphorus compounds, organic halogen compounds, organic phosphorus compounds containing halogen, etc. are used as flame retardants. Organic halogen compounds and organic phosphorus compounds containing halogen among the above compounds have the excellent flame proofing property.

However, these compounds generate hydrogen halide which causes corrosion of forming metal, heat deterioration of plastics itself and coloring by pyrolysis when forming the plastic goods. Additionally, hydrogen halide is toxic material which aggravates working environment and ill-affects the human body by generating toxic gas like hydrogen halide and dioxin when the outbreak of fire. Inorganic compounds like magnesium hydroxide and aluminum hydroxide are known as flame retardants not including halogen, but adding much amount is necessary for sufficient flame proofing, consequently the property of plastics itself deteriorates.

Due to the reason aforementioned above, organic phosphorus compounds is generally used as flame retardants which show relatively favorable flame proofing effects, for example an aromatic phosphate compounds like triphenylphosphate (TPP), tricresilphosphate (TCP), cresildiphenylphosphate (CDP) is included. Generally, TPP is used as a mixture with halogen compounds in order for flame proofing.

As a method for preparing a flame retardant including an organic phosphorus compound, Korean Registration Publication No. Patent 1994-0011789 discloses a flame retardant of PET ester group fiber fabric water and a method of manufacturing thereof. Especially, the prior art discloses a method for preparing an aromatic phosphate ester compound (DPPAP) which functions as a flame retardant, however, the method cannot improve the traditional method which is hard to composing the compound. Additionally, the prior art cannot suggest a detailed condition in relation to composing a compound such as the range of temperature, pressure and a method for separating the target compound.

Accordingly, the present invention is to provide a method for preparing an aromatic phosphate ester compound having a flame proofing property, furthermore, an optimal method for preparing an aromatic phosphate ester compound with best production yield.

Various theses and patent disclosures are referred in this disclosure and the citation is described. The entire contents of the cited theses and patent are incorporated herein by reference, and the technical field and contents of the present invention is described more clearly.

### DISCLOSURE

### Technical Problem

The inventors of the present invention did their best to develop a method for preparing a novel aromatic phosphate ester-based compound which is base material of a flame retardant. As a result, the inventors developed a method for preparing an aromatic phosphate ester-based compound which can induce composing a compound with best production yield by using multi-step heating process and refluxing circulation process. The inventors completed the present invention by assuring themselves that methods of the present invention can minimize the loss of raw materials by using a refluxing system, prevent from danger of explosion in case of manufacturing a compound having high reactivity by using a dual cooling system using a heating medium oil and water, and produce a compound having high purity by separating compounds using fractional distillation.

Accordingly, an object of the present invention is to provide a novel method for preparing an aromatic phosphate ester-based compound.

Another object of the present invention is to provide a novel dual cooling system.

Another object of the present invention is to provide a novel method for composing a compound.

Another object of the present invention is to provide a novel method for fractional distillation.

Another object of the present invention is to provide a novel low-temperature method for composing a compound.

Another object of the present invention is to provide a novel dual cooling apparatus.

Another object of the present invention is to provide a novel apparatus for composing a compound.

Another object of the present invention is to provide a novel fractional distillation apparatus.

Another object of the present invention is to provide a novel low-temperature apparatus for composing a compound.

Another object and advantageous effect is clearly described by the following specifications, claims and drawings.

### Technical Solution

In accordance with an aspect of the present invention, there is provided a method for preparing an aromatic phosphate ester-based compound which includes the steps of:

(a) reacting a compound expressed by a chemical formula 1 (i) and a C₆₋₁₀ aryl compound substituted with hydroxy or C₁₋₆ alkoxy, or a C₆₋₂₀ arylalkyl compound substituted with hydroxy or C₁₋₆ alkoxy (ii), which are used as reaction materials by gradually heating to the temperature levels of 90-125° C., 125-180° C., 180-210° C. and 210-240° C.;

(b) separating an aromatic phosphate ester-based compound from the resultant product of the step (a) under the condition of a pressure of 0.01 mmHg-50 mmHg and a temperature of 50° C.-300° C. by using fractional distillation; and

(c) reacting the aromatic phosphate ester-based compound separated in the step (b) (i) and C₁₋₁₀ alcohol or a nitrogen compound (ii) at a temperature of 10-70° C.;

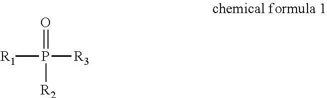

wherein R₁, R₂ and R₃ of the chemical formula 1 are, respectively and independently, halo (i), C₆₋₁₀ aryl substituted with hydroxy or C₁₋₆ alkoxy (ii), or C₆₋₂₀ arylalkyl substituted with hydroxy or C₁₋₆ alkoxy (iii); and one or more of R₁, R₂ and R₃ is halo.

As a result of research endeavor to develop a method for preparing a novel aromatic phosphate ester-based compound, the inventors of the present invention developed a method for preparing an aromatic phosphate ester-based compound which can induce composing a compound with best production yield by using multi-step heating process and refluxing circulation process. Traditional methods for preparing an aromatic phosphate ester-based compound had shortcomings of low production yield and the inventors of the present invention did their best to develop a method to improve the shortcomings, as a result, methods of the present invention has been developed. The inventors of the present invention assured themselves that methods of the present invention can minimize the loss of raw materials by using a refluxing system, prevent from danger of explosion in case of manufacturing a compound having high reactivity by using a dual cooling system using a heating medium oil and water, and produce a compound having high purity by separating compounds using fractional distillation.

In accordance with methods for preparing an aromatic phosphate ester-based compound of the present invention, gradual composing reaction of compounds is performed through four (4) step of heating and, especially, reaction materials which is not reacted can be inputted to the composing reaction again through refluxing in the composing reaction at respective temperature level. Additionally, in accordance with methods of the present invention, manufacturing time can be minimized because the manufacturer can be clearly aware of the time for heating to the next temperature level by measuring temperature change of the reaction system (for example, a reacting vessel or a distiller) at each heating level.

Hereinafter, the methods for preparing an aromatic phosphate ester-based compound of the present invention will be described in detail:

### Step (a): Heating of Reaction Materials

First of all, a compound expressed by a chemical formula 1 (i) and a C₆₋₁₀ aryl compound substituted with hydroxy or C₁₋₆ alkoxy, or a C₆₋₂₀ arylalkyl compound substituted with hydroxy or C₁₋₆ alkoxy (ii), which are used as reaction materials are reacted by heating gradually at specific range of temperature.

The chemical formula 1 is expressed as follow:

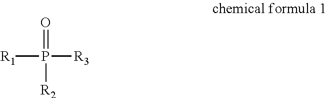

In the chemical formula 1, R₁, R₂ and R₃ are, respectively and independently, halo (i), C₆₋₁₀ aryl substituted with hydroxy or C₁₋₆ alkoxy (ii), or C₆₋₂₀ arylalkyl substituted with hydroxy or C₁₋₆ alkoxy (iii); and one or more of R₁, R₂ and R₃ is halo.

In this disclosure, a term “halo” which is used to define the compound expressed by the chemical formula 1 means halogen, for example, fluoro, chloro, bromo and iodo, and preferably chloro.

In this disclosure, a term “alkoxy” means -0alkyl group, for example, ethoxy, methoxy, etc. and in case that C₁₋₆ alkoxy is substituted carbon number of the substitution product is not counted.

In this disclosure, a term “aryl” means wholly or partially unsaturated mono- or poly-carbocyclic compound which is substituted or not substituted. C₆₋₁₀ aryl means aryl group having carbocyclic element of carbon number of 6 to 10, and in case that C₆₋₁₀ aryl is substituted carbon number of the substitution product is not counted. Preferably, aryl is monoaryl or biaryl. Preferably, monoaryl has carbon number of 5-6, and biaryl has carbon number of 9-10. Most preferably, aryl is phenyl which is substituted or not substituted. Monoaryl, for example, in case that phenyl is substituted, it can be substituted at various site with various substitution product, for example, halo, hydroxy, nitro, cyano, C₁-C₆ straight or branched chain alkyl which is substituted or not substituted, or C₁-C₆ straight or branched chain alkoxy. Preferably, aryl is phenyl which is not substituted.

In this disclosure, a term “C₆₋₂₀ arylalkyl” means alkyl group which is substituted with aryl group. C₆₋₂₀ aralkyl means aralkyl having aralkyl unit of carbon number of 6 to 20, and in case that C₆₋₂₀ aralkyl is substituted carbon number of the substitution product is not counted. Preferably, in aralkyl aryl is monoaryl or biaryl, and alkyl is C₁₋₃ alkyl, more preferably C₁ alkyl. In aralkyl aryl can be substituted at various site with various substitution product, for example, halo, hydroxy, nitro, cyano, C₁-C₄ straight or branched chain alkyl which is substituted or not substituted, C₁-C₄ straight or branched chain alkoxy, alkylcarboxylnitro, or combination thereof. Preferably, aryl is phenyl which is not substituted.

In accordance with a preferable embodiment of the present invention, R₁, R₂ and R₃ of the chemical formula 1 are, respectively and independently, halo (i), C₆ aryl substituted with hydroxy or C₁₋₃ alkoxy (ii), or C₆₋₁₀ arylalkyl substituted with hydroxy or C₁₋₃ alkoxy (iii).

The reaction temperature levels of the step (a) is 90-125° C., 125-180° C., 180-210° C. and 210-240° C., preferably 95-120° C., 135-180° C., 180-200° C. and 210-240° C., and more preferably 100-120° C., 140-180° C., 185-200° C. and 220-240° C.

Unlike traditional composing method for preparing an aromatic phosphate ester-based compound, one of the advantages of the present invention is that the loss of raw materials can be minimized by inducing a composing reaction of compounds using multi-step heating process, and by inducing again a composing reaction of reaction materials which is not reacted in a reacting vessel using a refluxing circulation apparatus.

In this disclosure, “reflux” means, distillation in wide use, the flow of compound vapor which steams up through a distillation column, and then is condensed to liquid state, and then flows down along the inner wall of the distillation column. That is, reflux is for increasing the composing reaction in the reacting vessel. In the composing reaction of the step (a) of the present invention, a refluxing circulation of reaction materials or resultant products of the step (a) occurs at each temperature level to be heated.

In accordance with a detailed embodiment of the present invention, PDCP, DPCP and TPP can be produced by heating a mixture of phosphorous oxychloride (POCl₃) and phenol to the temperature of 102° C. However, phosphorous oxychloride (POCl₃) and phenol which is not reacted may remain in reaction materials at that temperature level, and the reaction of theses reaction materials which is not reacted can be induced by heating to the boiling point of phosphorous oxychloride (POCl₃) and phenol. In this case, through refluxing process, compound vapor of the reaction materials is restored to the reaction vessel in which the composing reaction of the compound occurs.

### Step (b): Separating of an Aromatic Phosphate Ester-Based Compound

Subsequently, an aromatic phosphate ester-based compound is separated from the resultant product of the step (a) under the specific condition of temperature and pressure by using fractional distillation.

In this disclosure, a term “fractional distillation” means a method used when separating a mixture containing various compounds by using the difference of the boiling point, that is, a method for separating a mixture using a distillation column. Materials of similar boiling point gather together while the mixture steams up through the distillation column, and these are separated to pure materials.

The range of heating temperature for the fractional distillation is below 300° C., considering the inside material of a distiller used for the fractional distillation. Because the inside of the distiller is coated with glass or carbon, preferably the temperature range for the fractional distillation is below 300° C. More preferably, the temperature range for the fractional distillation is 50° C.-300° C. More preferably, the step (b) will be performed at around the boiling point of each compound which separated by the fractional distillation. For example, the boiling point of PDCP, DPCP and TPP, which composed by reaction of phosphorous oxychloride (POCl₃) and phenol in accordance with the embodiment of the present invention, is 241-243° C. (at 760 mmHg), 314-316° C. (at 488 mmHg) and 244-245° C. (at 11 mmHg) respectively, and each compound can be separated at each boiling point by heating the compound to the boiling point.

Because the fractional distillation should be performed below the temperature of 300° C. considering the inside material of a distiller used for the fractional distillation, depressuriz7ing the inside of the distiller is essentially required. The depressurizing process can be performed by using various publicly known decompression devices, for example, a vacuum pump connected to the distiller-distillation column. In case that the pressure state near a vacuum is formed by using the vacuum pump, the boiling point of the compound to be separated can be reduced. Preferably, the fractional distillation can be performed under the condition of a pressure of 0.01 mmHg-50 mmHg, more preferably 0.1 mmHg-35 mmHg, still more preferably 0.1 mmHg-20 mmHg, far more preferably 1 mmHg-20 mmHg.

The compound separated by the step (b) can move again to the step (a), the step for composing a compound, and be inputted to the additional reaction. For example, PDCP separated by the fractional distillation moves to the step (a) and can produce DPCP by reacting with phenol additionally.

### Step (c): Low-Temperature Composing of an Aromatic Phosphate Ester-Based Compound

The final aromatic phosphate ester-based compound is composed by reacting the aromatic phosphate ester-based compound separated in the step (b) and C₁₋₁₀ alcohol or a nitrogen compound at low-temperature.

In this disclosure, a term “alcohol” means a compound, which is composed by coupling hydroxyl group to carbon element of alkyl or substituted alkyl group. C₁₋₁₀ alcohol means an alcohol compound having alcohol unit of carbon number of 1 to 10, and in case that C₁₋₁₀ alcohol is substituted carbon number of the substitution product is not counted. Preferably, alcohol is C₁₋₅ alcohol, more preferably, C₁₋₃ alcohol.

In this disclosure, a term “nitrogen compound” means a compound including “nitrogen (N)”, for example, propylamine, butylamine, pentamine, hexamine are included. Preferably, nitrogen compound is propylamine or butylamine.

The aromatic phosphate ester-based compound separated in the step (b) makes explosive exothermic reaction with alcohol or a nitrogen compound because it generally includes acid gas (for example, chlorine gas). Accordingly, the nitrogen compound should be inputted while dropping, heat generated from the reaction should be cooled, and the composing reaction of the step (c) should be performed while maintaining low-temperature. Preferably, the range of low-temperature is 10-70° C., more preferably, 10-50° C., still more preferably, 10-40° C., far more preferably, 20-35° C.

In accordance with a preferable embodiment of the present invention, the resultant product of the step (c) in itself is difficult to be used as flame retardant immediately, because it includes much acid gas, for example chlorine gas. Accordingly, a step for neutralizing the resultant product of the step (c) can be included additionally after the step (c). A basic compound, for example NaOH can be used for neutralizing step.

In the neutralizing step, by-product (salts and H₂O) due to the neutralizing reaction are produced, and a step for removing the by-product can be included additionally. For example, NaCl produced by the reaction of NaOH and chlorine gas can be removed by adding ethanol, methanol, or toluene as a solvent, and the organic solvent can be removed by the reaction for desolventizing later. Meanwhile, by-product H₂O due to the neutralizing reaction can be removed by drying process like vacuum dry, etc.

The method for preparing an aromatic phosphate ester-based compound of the present invention generates much heat during the reaction of the compounds or the fractional distillation process of the step (a) to the step (c), and a step for cooling the heat can be included additionally.

In accordance with a preferable embodiment of the present invention, the step for the cooling heat generated during the reaction of the compounds or the fractional distillation of the step (a) to the step (c) is performed by using a dual cooling system including the steps for condensing compound vapor vaporized during the step (a) to the step (c) using heating medium oil or silicone oil as cooling fluid (i), and cooling the heating medium oil heated in the step (i) using water as cooling fluid (ii). The dual cooling system cools the heat generated during the refluxing of the compounds by using the heating medium oil instead of the cooling water. This is a safety device for preventing from danger of explosion in case of manufacturing a compound having high reactivity. In case that the cooling fluid leaks from the cooler and the cooling fluid is water, explosive reaction may occur due to the reaction with the compounds. Accordingly, the heating medium oil or silicone oil is used instead of the cooling water. The heated heating medium oil moves to the cooler containing the cooling water and be cooled there.

In accordance with a preferable embodiment of the present invention, the aromatic phosphate ester-based compound prepared by the method of the present invention is expressed by a chemical formula 2 to a chemical formula 5 as follows:

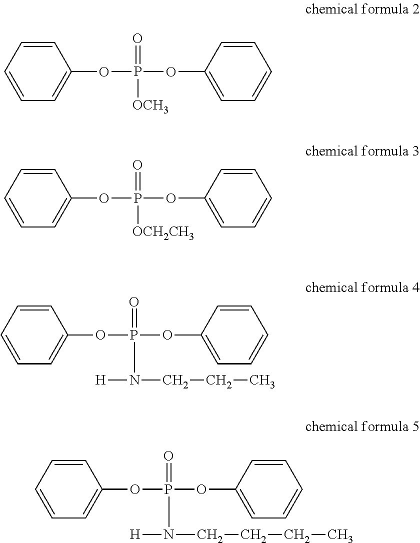 [SMILES: COP(=O)(Oc1ccccc1)Oc1ccccc1 ; CCOP(=O)(Oc1ccccc1)Oc1ccccc1 ; CCCNP(=O)(Oc1ccccc1)Oc1ccccc1 ; CCCCNP(=O)(Oc1ccccc1)Oc1ccccc1]

In accordance with another aspect of the present invention, there is provided a dual cooling system which includes the steps of:

(a) a first step for cooling materials to be cooled using heating medium oil or silicone oil as cooling fluid; and

(b) a second step for cooling the heating medium oil heated in the first cooling step using water as cooling fluid.

The cooling fluid is a medium which takes and transports to the outside the heat generated from the cooler while passing through the inside of the cooler. Although various publicly know materials can be used as the cooling fluid, preferably the heating medium oil or silicone oil, and cooling water is used in accordance with the present invention.

In accordance with a preferable embodiment of the present invention, the materials to be cooled of the step (a) have high reactivity with water. For example, in case of cooling the materials having high reactivity with water by using the cooling water, when the cooling water leaks it is apprehended that explosion occurs by reaction of the cooling water and the material to be cooled. Accordingly, the dual cooling system, for preventing from the danger of explosion, which uses the heating medium oil having relatively very low reactivity for cooling of the materials to be cooled and uses the cooling water for the heated heating medium oil, can be used.

The materials to be cooled is reactive materials, which is the generic term for materials having high reactivity like unstable materials which cause decomposition and combustion, explosion with slight energy, or ignitable materials which easily ignites when contacting with air, water, etc., or incompatible hazard materials which is easily produced when composing two or more of materials.

In accordance with another aspect of the present invention, there is provided a method for composing a compound which includes the steps of:

(a) reacting two or more of reaction materials by heating;

(b) refluxing compound vapor that the reaction material and the resultant product of the step (a) is vaporized by condensing; and

(c) cooling heat generated during the step (a) and the step (b), wherein the step (c) is performed by using a dual cooling system including the steps of condensing compound vapor vaporized during the step (a) to the step (b) using heating medium oil or silicone oil as cooling fluid (i), and cooling the heating medium oil heated in the step (i) using water as cooling fluid (ii).

In accordance with a preferable embodiment of the present invention, the composing method is performed in a reacting vessel having an inner wall coated with glass or carbon.

Hereinafter, the composing method of the present invention will be described in detail:

### Step (a): Heating of the Reacting Materials

First of all, two or more of reacting materials are heated and a composing reaction is induced. The optimal heating temperature can be decided considering the boiling point of the reacting materials.

### Step (b): Refluxing of the Reacting Materials and the Resultant Product

The reacting materials and the resultant product are vaporized and steam up when the temperature reaches their boiling point. This compound vapor contains materials which is not reacted and is refluxed in order to be inputted to the reaction again. That is, the compound vapor is restored to the reaction system for composing reaction again by cooling and condensing the compound vapor.

### Step (b): Cooling

Heat generated during the step (a) and the step (b) is cooled. The cooling process uses the dual cooling system, that is, the dual cooling system which includes the steps of condensing compound vapor vaporized during the step (a) to the step (b) using heating medium oil or silicone oil as cooling fluid (i), and cooling the heating medium oil heated in the step (i) using water as cooling fluid (ii).

As described above, the composing method of the present invention includes the steps of heating of the reacting materials, refluxing and cooling of the vaporized compound by using the dual cooling system, and each step is described to be performed step by step, however, this is for convenient description. The heating, refluxing and cooling process of the composing method of the present invention can be performed in order (i), or at the same time (ii).

In accordance with another aspect of the present invention, there is provided a method for fractional distillation which includes the steps of:

(a) depressurizing pressure of a reaction system containing a resultant product including two or more of compounds and chlorine gas by using a vacuum pump;

(b) collecting the chlorine gas included in the resultant product from the depressurizing process of the step (a);

(c) heating the two or more of compounds included in the resultant product of the step (a) from which the chlorine gas is removed; and

(d) condensing compound vapor vaporized from the compounds of the step (c) by cooling.

In accordance with a preferable embodiment of the present invention, the method for fractional distillation is performed in a distiller having an inner wall coated with glass or carbon.

Hereinafter, the method for fractional distillation of the present invention will be described in detail:

### Step (a): Depressurizing

First of all, pressure of a reaction system containing a resultant product including two or more of compounds and chlorine gas is depressurized by using a vacuum pump.

The depressurizing process is for decreasing the boiling point of the two or more of compounds and separating the chlorine gas. The fractional distillation, as described above, is performed in a distiller having an inner wall coated with glass or carbon, accordingly below the temperature of 300° C. Accordingly, the depressurizing process for decreasing the boiling point of the compound to be separated is essentially required.

### Step (b): Collecting of Chlorine Gas

Subsequently, the chlorine gas included in the resultant product from the depressurizing process of the step (a) is collected. The chlorine gas passing through the vacuum pump due to the depressurizing process of the step (a) can be stored in a separate storing tank, and the collected chlorine gas can be stored by dissolving in H₂O or neutralized by using NaOH. In the present invention, the step (a) and the step (b) is performed separately, however, this is for convenient description. Collecting of the chlorine gas and depressurizing process can be performed at the same time.

### Step (c): Heating

The two or more of compounds included in the resultant product of the step (a) from which the chlorine gas is removed is heated to the boiling point of each compound. The boiling point of the compound decreases due to the depressurizing process of the step (a) and a compound vapor is generated when the temperature reaches the decreased boiling point.

### Step (d): Cooling

The compound vapor vaporized from the compounds of the step (c) is condensed by cooling. The condensed compounds are stored in a separate storing vessel, and this is the final compound separated by the method for fractional distillation of the present invention.

In accordance with another aspect of the present invention, there is provided a low-temperature method for composing an aromatic phosphate ester-based compound having one of a chemical formula 2 to a chemical formula 5 which includes the steps of:

(a) reacting phenyldichlorophosphate, diphenylchlorophosphate, or an aromatic phosphate ester-based compound of phenyldichlorophosphate and diphenylchlorophosphate (i) and a C₁₋₁₀ alcohol or nitrogen compound (ii), which are used as reaction materials by stirring at a temperature of 10-70° C.;

(b) reacting while maintaining the temperature of 10-70° C. by cooling heat generated from the reaction of the step (a);

(c) neutralizing the compound having one of the chemical formula 2 to the chemical formula 5 which is the resultant product of the step (b); and

(d) removing H₂O and salts produced by the neutralizing reaction of the step (c).

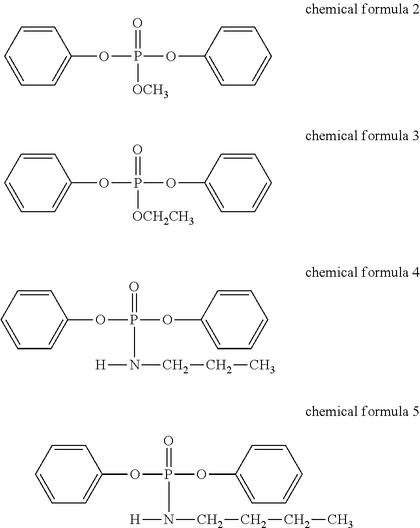 [SMILES: COP(=O)(Oc1ccccc1)Oc1ccccc1 ; CCOP(=O)(Oc1ccccc1)Oc1ccccc1 ; CCCNP(=O)(Oc1ccccc1)Oc1ccccc1 ; CCCCNP(=O)(Oc1ccccc1)Oc1ccccc1]

Hereinafter, the low-temperature method for composing a compound of the present invention will be described in detail:

### Step (a) and (b): Low-Temperature Stirring and Reacting

First of all, phenyldichlorophosphate, diphenylchlorophosphate, or an aromatic phosphate ester-based compound of phenyldichlorophosphate and diphenylchlorophosphate (i) and a C₁₋₁₀ alcohol or nitrogen compound (ii), which are used as reaction materials, are reacted by stirring at a temperature of 10-70° C. The reason for composing the compound at low-temperature is an explosive reaction due to very high reactivity between the compounds, and decomposition or discoloration of the compounds above the temperature of 70° C. Additionally, in case that the temperature of a reacting vessel in which the composing reaction performed increases due to heat generated from the reaction, the reacting vessel may be melted down, fractured, or cracked. Accordingly, when the low-temperature composing, a separate cooling step for maintaining the reaction system, in which the composing reaction of the reaction materials is performed, is required. The compounds is reacted continuously while maintaining the temperature of 10-70° C. by cooling heat generated from the reaction of the step (a);

Preferably, C₁₋₁₀ alcohol of the step (a) is C₁₋₅ alcohol, more preferably, C₁₋₃ alcohol, still more preferably, C₁₋₂ alcohol.

Preferably the reaction temperature of the step (b) is 10-70° C., more preferably, 10-50° C., still more preferably, 10-40° C., far more preferably, 10-30° C.

After the step (b), a step for maturing the resultant product of the step (b) below a temperature of 80° C. without cooling process can be included additionally. Because no more of cooling process is performed in the step (c) increasing of the temperature to some degree due to the finish of the step (b) is predictable. That is, the maturing step is performed between a temperature of 10-30° C. as the lowest temperature which is the reaction temperature of the step (b) and 70-80° C. as the highest temperature which is the highest reaction temperature of the step (a).

### Step (c): Neutralizing

Subsequently, the resultant product of the step (b) is neutralized. In the neutralizing reaction various publicly know acidic or basic materials can be used, for example, HCl, H₂SO₄, HNO₃ and CH₃COOH can be used as acidic materials, and NaOH, Ca₂OH and NH₄OH can be used as basic materials.

In accordance with a detailed embodiment of the present invention, the resultant product of the step (b) is acidic, and neutralized by using NaOH.

### Step (d): Removing of H₂O and Salts

H₂O and salts is necessarily produced by the neutralizing reaction of the step (c), and a step for removing these materials is included.

The H₂O can be removed by using various publicly known drying methods, for example, vacuum dry method. The salts can be removed by adding a solvent which dissolves the salts, for example, in case of removing NaCl an organic solvent (ethanol, methanol, or toluene) can be used. The solvent can be removed by publicly known desolventizing method.

In accordance with another aspect of the present invention, there is provided a dual cooling apparatus 100 which includes:

(a) a first cooling device 101 using heating medium oil as cooling fluid, formed with lines through which materials to be cooled are passable in the cooling device, and cooling the temperature by passing the materials to be cooled through the lines; and

(b) a second cooling device 102 using water as cooling fluid, and cooling the temperature of the heating medium oil heated in the first cooling device by passing the heated heating medium oil in the first cooling device through the inner space of the cooling device.

The dual cooling apparatus of the present invention uses the dual cooling system of the present invention as described above. Particularly, the dual cooling apparatus of the present invention is for cooling reactive materials, and more particularly, for preparing an aromatic phosphate ester-based compound.

In accordance with a preferable embodiment of the present invention, the materials to be cooled have high reactivity with water.

The dual cooler for preparing an aromatic phosphate ester-based compound of the present invention is configured with a first cooling device and a second cooling device (see FIG. 1). The first cooling device uses heating medium oil (for example, silicone oil) as cooling fluid, and is formed with a plurality of lines through which materials to be cooled are passable in the cooling device. As shown in FIG. 1, the materials to be cooled can move from the lower direction to the upper direction of the plurality of the lines. The temperature of the materials decreases by passing the materials to be cooled through the inside space of the cooler. As shown in FIG. 1, the materials to be cooled passing though the inside of the cooler is cooled while the cooling fluid moves from one direction to the other direction of the first cooling device. The cooling fluid heated in the first cooling device moves from one direction to the other direction of the second cooling device by a forced circulation pump. Meanwhile, the second cooling device uses water as cooling fluid, and is formed with a plurality of lines through which the cooling fluid of the first cooling device is passable. The cooling fluid of the first cooling device moves from one direction to the other direction of the second cooling device, and the first cooling fluid (heating medium oil) cooled in the second cooling device returns to the first cooling device again.

In accordance with another aspect of the present invention, three is provided an apparatus 200 for composing a compound which includes:

(a) a reacting vessel 201 containing two or more of reaction materials and in which a chemical reaction of the reaction materials is performed;

(b) a refluxing circulator 202 installed to the upper part of the reacting vessel 201 and refluxing compound vapor vaporized in the reacting vessel to the reacting vessel by condensing; and

(c) a dual cooler 203, as a cooler for cooling heat generated in the refluxing circulator 202 installed to the reacting vessel, including a first cooler 203A using heating medium oil as cooling fluid, installed to the outer part of the refluxing circulator, and condensing the compound vapor vaporized in the reacting vessel (i), and a second cooler 203B using water as cooling fluid, formed with a plurality of lines through which the cooling fluid of the first cooler is passable in the cooler, and cooling the heated heating medium oil of the first cooler.

The apparatus for composing a compound of the present invention uses the method for composing a compound of the present invention as described above. Common description between the two is omitted in order to avoid the complexity of the description.

In accordance with a preferable embodiment of the present invention, the reacting vessel 201 containing two or more of reaction materials and in which a chemical reaction of the reaction materials is performed (i), and the refluxing circulator 202 installed to the upper part of the reacting vessel 201 and refluxing compound vapor vaporized in the reacting vessel to the reacting vessel by condensing (ii), have the inner walls coated with glass or carbon.

The refluxing circulator 202 is installed to the upper part of the reacting vessel 201 and a compound vapor generated from the reacting vessel steams up through the refluxing circulator.

In the refluxing circulator installed to the reacting vessel, much heat is generated due to the compound vapor and heating reaction. Accordingly, a cooler for cooling the heat and condensing the compound vapor is required. The apparatus for composing a compound of the present invention, as a cooler, uses a dual cooler 203 including a first cooler 203A using heating medium oil (for example, silicone oil) as cooling fluid and condensing the compound vapor vaporized in the reacting vessel (i), and a second cooler 203B using water as cooling fluid and cooling the heated heating medium oil of the first cooler

The dual cooler installed to the refluxing circulator 202 is configured with a first cooler and a second cooler (see FIG. 1 and FIG. 2). The first cooler 203A uses heating medium oil as cooling fluid, and is installed to the outer part of the refluxing circulator 202. As shown in FIG. 2, the heat generated from the refluxing circulator is cooled while the cooling fluid (heating medium oil) moves from the lower direction to the upper direction of the first cooler by a forced circulation pump. The cooling fluid heated in the first cooler moves from one direction to the other direction of the second cooler by the forced circulation pump. Meanwhile, the second cooler uses water as cooling fluid, and the water is circulated in the inside of the second cooler by another forced circulation pump (not shown in FIG. 2). The inside of the second cooler is formed with a plurality of lines through which the cooling fluid of the first cooler is passable. The cooling fluid of the first cooler moves from one direction to the other direction of the second cooler, and the first cooling fluid (heating medium oil) cooled by the second cooler returns to the first cooler again.

In accordance with another aspect of the present invention, there is provided a fractional distillation apparatus 300 which includes:

(a) a distiller 301 containing a resultant product including two or more of compounds and chlorine gas;

(b) a distillation column 302 installed to the upper part of the distiller 301 and through which compound vapor vaporized in the distiller passes;

(c) a cooler 303 for condensing the compound vapor vaporized in the distiller 301;

(d) a storing vessel 304 storing a compound condensed in the step (c);

(e) a vacuum pump 305 depressurizing pressure in the distiller 301 and for collecting the chlorine gas in the distiller; and

(f) a storing vessel 305 storing the chlorine gas collected by the vacuum pump 305.

The fractional distillation apparatus of the present invention uses the method for fractional distillation of the present invention as described above. Common description between the two is omitted in order to avoid the complexity of the description.

In accordance with a preferable embodiment of the present invention, the distiller 301 and the distillation column 302 have the inner walls coated with glass or carbon.

In accordance with a preferable embodiment of the present invention, in the fractional distillation apparatus 300, temperature sensors 308 are installed to the lower part of the distiller 301, the connecting portion 307 of the distiller 301 and distillation column 302, and the upper part of the distillation column 302 in order to measure temperature of the compound contained in the distiller 301 or the compound vapor vaporized in the distiller 301.

The distillation column 302 is for separating two or more of mixture materials by using the difference of the boiling point. Inside of the distillation column is filled with shards of glass material (for example, lacering, cylindrical shard of glass having a diameter of 2.5 cm, a height of 3 cm) in order to increase the moving distance of the compound vapor and induce the condensing of the vapor by increasing the resistance when moving. The shards of glass is made of materials which have no reactivity with the compounds or the compound vapor and are not ruptured or deformed around the boiling point of the compound.

In the configuration of the (c), the cooler 303 for condensing the compound vapor vaporized in the distiller 301 can use various publicly known cooling devices, preferably the dual cooler of the present invention.

In the configuration of the (d), the storing vessel 304 storing the condensed compound can be configured in plurality according to the kinds of the compounds, and each storing vessel is configured for opening and closing by using a valve.

In the configuration of the (f), the storing vessel 306, preferably the upper part of the storing vessel 306 is filled with acid-resistant shards of glass or plastic (for example, poling, modified polyesterelastomer (PEE) or polytetrafluoroethylene), while the chlorine gas steams up through the shards of glass or plastic it can be stored by dissolving in water flows from the upper part of the storing vessel 306.

In accordance with another aspect of the present invention, there is provided a low-temperature apparatus 400 for composing a compound which includes:

(a) a reacting vessel 401 containing two or more of reaction materials and in which a chemical reaction of the reaction materials is performed;

(b) a dual cooler 402, as a dual cooler 402 for cooling heat generated in the reacting vessel 401, installed to the lower part or the side part of the reacting vessel 401 and including a first cooler using heating medium oil as cooling fluid, installed to the outer part of the reacting vessel, and cooling heat generated in the reacting vessel (i), and a second cooler using water as cooling fluid, formed with a plurality of lines through which the cooling fluid of the first cooler is passable in the cooler, and cooling the heated heating medium oil of the first cooler.

(c) a storing vessel 403 installed to the upper part or the side part of the reacting vessel 401, and containing a compound for neutralizing the resultant product contained in the reacting vessel 401 or additional reaction materials reacting with the reaction materials in the reacting vessel 401.

The low-temperature apparatus for composing a compound of the present invention uses the low-temperature method for composing a compound of the present invention as described above. Common description between the two is omitted in order to avoid the complexity of the description.

In accordance with a preferable embodiment of the present invention, the low-temperature apparatus 400 for composing a compound can further include a stirrer 404 stirring the reaction materials in the reacting vessel 401.

In the configuration of the (b), the cooler 402 for cooling heat generated in the reacting vessel 401, installed to the lower part or the side part of the reacting vessel 401 can use various publicly known cooling devices, preferably the dual cooler of the present invention.

The dual cooler included in the low-temperature apparatus 400 for composing a compound of the present invention is configured with a first cooling device and a second cooling device (see FIG. 1 and FIG. 4). The first cooling device 402A uses heating medium oil (for example, silicone oil) as cooling fluid, and is installed to the outer part of the reacting vessel 401. The reacting vessel is cooled while the cooling fluid moves from one direction (the lower direction) to the other direction (the upper direction) of the first cooling device installed to the outer part of the reacting vessel. The heating medium oil heated by the heat generated from the reacting vessel moves from one direction to the other direction of the second cooling device by a forced circulation pump. Meanwhile, the second cooling device uses water as cooling fluid, and the water is circulated in the inside of the second cooling device by the forced circulation pump (not shown). The inside of the second cooling device is formed with a plurality of lines through which the heating medium oil of the first cooling device is passable. The cooling fluid of the first cooling device moves from one direction to the other direction of the second cooling device, and the heating medium oil cooled by the second cooling device returns to the first cooling device in order for cooling the reacting vessel again.

In the configuration of the (c), the low-temperature apparatus for composing a compound can further include a cooler 405 for cooling refluxing vapor generated from the chemical reaction of the reaction materials. In case that the composing reaction in the reacting vessel 401 is an exothermic reaction and much heat is generated, vapor of the reacting materials and resultant product can be generated, and in order to restore the vapor to the compounds in the reacting vessel 400 again by condensing the cooler is required. In accordance with a detailed embodiment of the present invention, the additional reaction material is butylamine, the butylamine is dropped into the reacting vessel, and the vapor of butylamine and the composing compound vaporized from the reacting vessel 401 is restored to the reacting vessel 401 again while condensing by the cooler. The cooler can use various publicly known cooling devices, preferably the dual cooler of the present invention.

The dual cooler is configured with a first cooling device and a second cooling device (see FIG. 1 and FIG. 4). The first cooling device 405A uses heating medium oil (for example, silicone oil) as cooling fluid, and the inside of the first cooling device is formed with a plurality of lines through which the butylamine vapor or the compound vapor vaporized from the reacting vessel is passable. The compound vapor is condensed while moving from one direction to the other direction of the first cooling device 405A, and the heating medium oil passing through the first cooling device moves from one direction to the other direction of the second cooling device 405B by a forced circulation pump. Meanwhile, the second cooling device 405B uses water as cooling fluid, and the inside of the second cooling device is formed with a plurality of lines through which the cooling fluid of the first cooling device is passable. The cooling fluid of the first cooling device moves from one direction to the other direction of the second cooling device 405B, and the cooled cooling fluid returns to the first cooling device 405A in order for cooling the compound vapor again.

### Advantageous Effects

In accordance with the aforementioned structure of the present invention, the technical features and the advantageous effects of the present invention can be summarized as follows:

(a) The present invention relates to a method for preparing a novel aromatic phosphate ester-based compound.

(b) The method of the present invention can induce composing a compound with best production yield by using multi-step heating process and refluxing circulation process.

(c) That is, the loss of raw materials can be minimized by using a refluxing system, danger of explosion in case of manufacturing a compound having high reactivity can be prevented by using a dual cooling system using a heating medium oil and water, and a compound having high purity can be produced by separating compounds using fractional distillation.

(d) By producing the compound having high purity, the amount of the flame retardant used when flame proofing can be adjusted, and the compound can be used for flame proofing not only for general textile products but also for some products requiring a test of safety/toxicity

(e) Additionally, the aromatic phosphate ester-based compound in accordance with the method of the present invention can be used for flame proofing materials for textile, artificial leather, vertical blind, sponge, and Styrofoam for building or polyurethane.

### DESCRIPTION OF DRAWINGS

FIG. 1 shows a dual cooling device 100 of the present invention schematically.

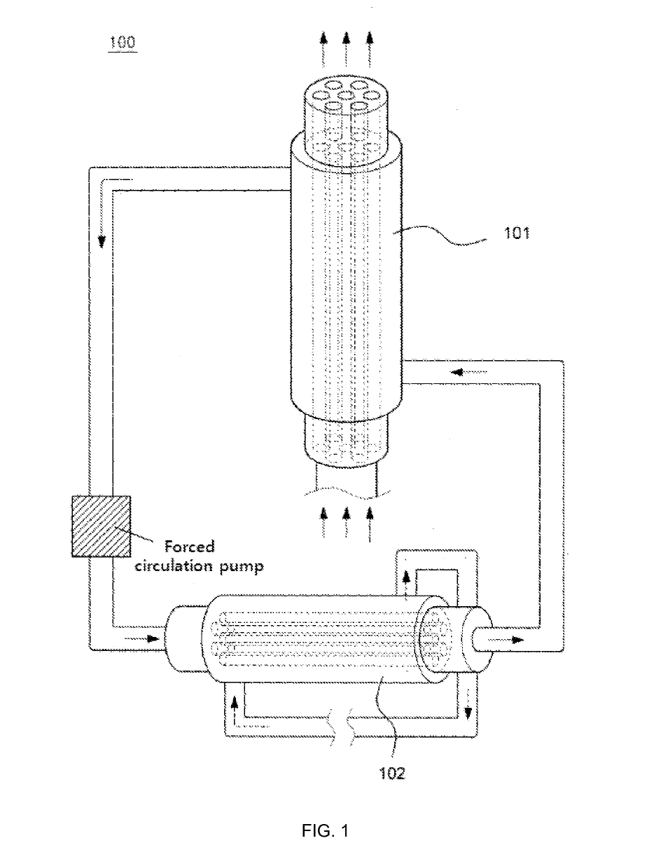

FIG. 2 shows an apparatus 200 for composing a compound of the present invention schematically.

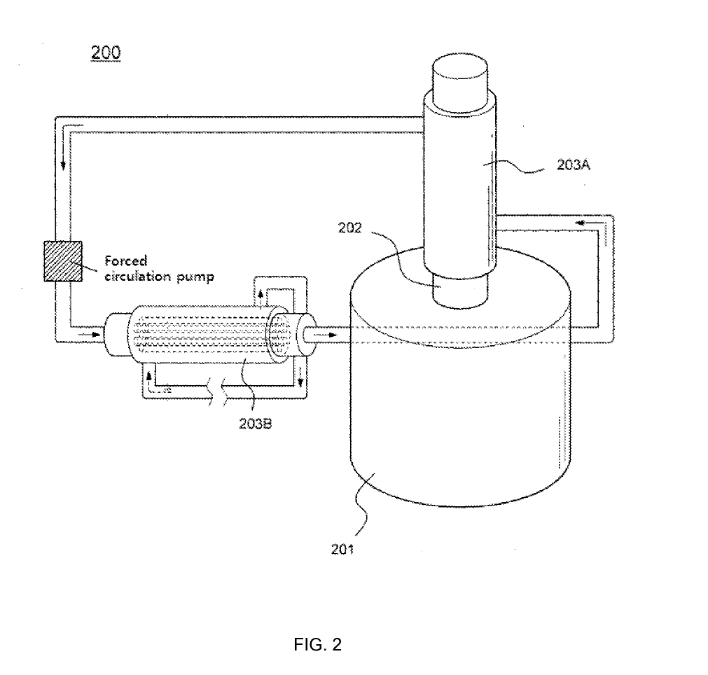

FIG. 3 shows a fractional distillation apparatus 300 of the present invention schematically.

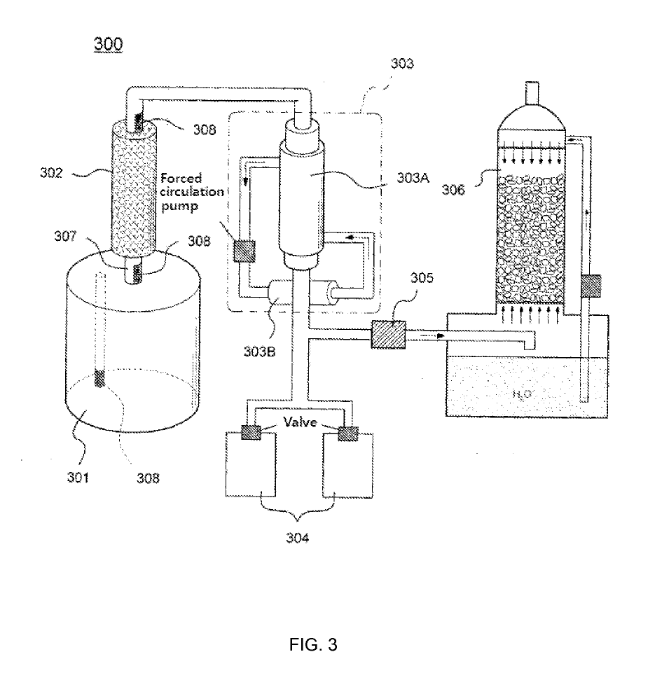

The cooler 303 is a dual cooler, and configured with the first cooler 303A and the second cooler 303B.

FIG. 4 shows a low-temperature apparatus 400 for composing a compound of the present invention schematically.

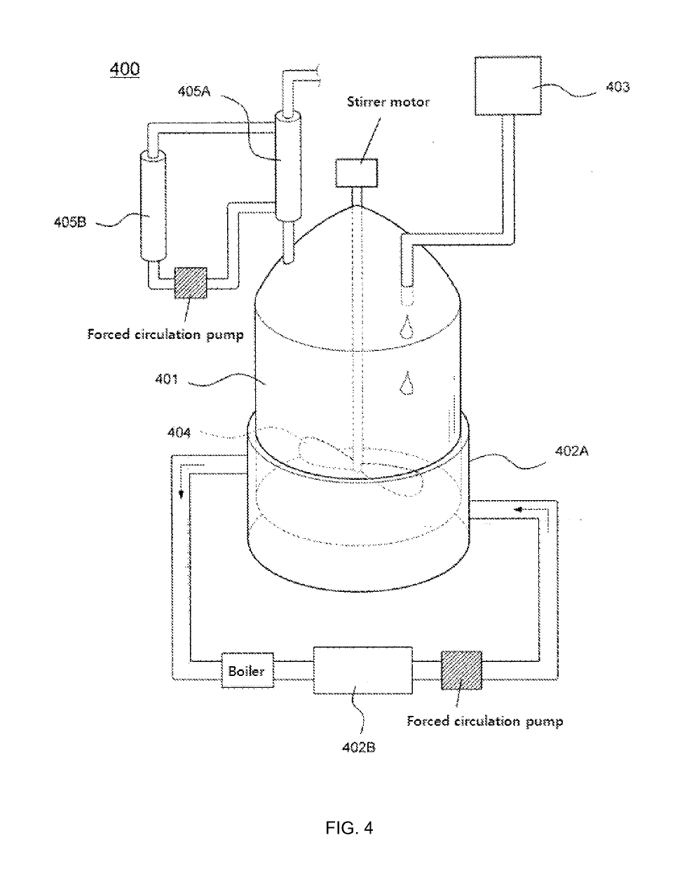

### BEST MODE

### Mode for Invention

Exemplary embodiments of the present invention will be described in detail. These exemplary embodiments are only for detailed description of the present invention, serve only for describing the present invention and by no means limit or restrict the spirit and scope of the present invention. Thus, any person of ordinary skill in the art shall understand that a large number of permutations and other equivalent embodiments are possible.

### EXEMPLARY EMBODIMENTS

### Exemplary Embodiment 1

### Composing of DPCP (Diphenylchlorophosphate)

### First Reaction: Composing of PDCP (Phenyldichlorophosphate)

500 kg of Phosphorylchloride (POCl₃) (BASF, Germany) as base material was inputted to a first composing reaction tank 201 (Sewon G tech, Republic of Korea), and phenol (Kumho chemical, Republic of Korea) which is liquefied in a storing tank at a temperature of 50° C. was added to the first composing reaction tank 201. The amount of the phenol added was about twice of the mol ratio of the phosphorylchloride. A refluxing circulator 202, to which a cooler is attached, is connected to the upper part of the reacting vessel, the cooler is configured with a first cooler 203A using heating medium oil (Isu chemical) as cooling solvent and a second cooler 203B using water, the first cooler is for refluxing vapor generated from the first composing reaction tank again, and the second cooler is for cooling the heating medium oil which is the cooling solvent of the first cooler when heated. The inside of the first composing reaction tank 201 and the cooler 203A and 203B was coated with glass or carbon so that the reaction at a high temperature was possible.

First of all, the coupling reaction of the phosphorylchloride and the phenol was induced by heating the first composing reaction tank 201 to a temperature of 102° C. which is the boiling point of the phosphorylchloride (about 12 hours). The refluxing process that the vapor generated during the heating returns to the reaction tank with being condensed by the cooler connected to the upper part of the composing reaction tank was repeated. The loss of the reaction materials in the first composing reaction tank was minimized by the refluxing process.

The temperature was increased from the temperature of 102° C. to a temperature of 140° C. at the time when the refluxing process proceeded no more. At the temperature of 140° C., the materials in the first composing reaction tank were reacted continuously while the refluxing process was repeated (about 2 hours). The temperature of the composing reaction can be increased from the temperature of 140° C. to a near temperature of 180° C. which is the boiling point of the phenol, and in this case the composing reaction of PDCP can be completed in a short time due to the more active composing reaction. The completion time of the first reaction was when the refluxing process proceeded no more at the temperature of 140° C. At the completion time of the first reaction, there existed PDCP (phenyldichlorophosphate), DPCP (diphenylchlorophosphate), TPP (triphenylphosphate) and phenol which is not reacted in the first composing reaction tank.

### Second Reaction: Composing of DPCP (Diphenylchlorophosphate)

After the first reaction, a second reaction was performed by heating the temperature of the first composing reaction tank 201 to a temperature of 182° C. which is the boiling point of the phenol. The temperature was increased from the temperature of 182° C. to a near temperature of 240° C. which is the boiling point of the PDCP (phenyldichlorophosphate) at the time when the refluxing process by the cooler proceeded no more. The completion time of the second reaction was when the refluxing process proceeded no more. In case that the temperature is above a temperature of 241° C.-243° C., the refluxing of the PDCP composed may occur continuously. Accordingly, it is preferable not to increase the temperature above 240° C.

At the completion time of the second reaction, there existed, comparing with the total compound, 25 weight % of PDCP (phenyldichlorophosphate), 65-70 weight % of DPCP (diphenylchlorophosphate), 10 weight % of TPP (triphenylphosphate) and chlorine gas (012) in the first composing reaction tank.

### Exemplary Embodiment 2

### Separating of the Composing Compound by Using Fractional Distillation

After transferring the compounds produced in the second reaction to a distiller 202 (Sewon G tech, Republic of Korea), the compounds were separated according to the boiling point of each compound. The boiling point of PDCP, DPCP and TPP is 241-243° C. (at 760 mmHg), 314-316° C. (at 488 mmHg) and 244-245° C. (at 11 mmHg) respectively, and PDCP having lower boiling point was separated first and the others were separated in order. A distillation column 302 is connected to the upper part of the distiller, and temperature sensors are installed to the lower part of the distiller, the connecting portion of the distiller and the distillation column, and the upper part of the distillation column. Whether the distillation of the compound is completed can be decided according to the temperature of vapor passing near the temperature sensors.

The line connected to the distillation column continues to a cooler 303, this cooler is also configured with a first cooler and a second cooler. The line connected to the cooler is divided into two (2) lines, and these lines continue to a storing vessel 304 which can be opened and closed by using a valve and a vacuum pump 305 (Woosung, Republic of Korea) respectively.

The chlorine gas among the compounds produced in the second reaction moves to a storing vessel containing water or NaOH (aqueous) through the vacuum pump 305, and is stored in a state of hydrochloric acid (HCl) or H₂O/salts by reacting with the water or NaOH in the storing vessel 306. The inside of the storing vessel 306 is filled with acid-resistant shards of plastic (poling), the chlorine gas is stored in a state of hydrochloric acid by water which flows from the upper part of the storing vessel 306 while the chlorine gas steams up through the shards of plastic. A plate formed with a plurality of pores is located in the upper part of the storing vessel 306 so that the water flows equally. The hydrochloric acid can be stored together with the water or in separate storing vessel. The water moves to the upper part of the storing vessel 306 by a forced circulation pump.

In order to separate each compound from the compounds produced in the second reaction, the pressure in the distiller was depressurized to a pressure of 15 mmHg (15 torr) which is lower than the atmospheric pressure (760 mmHg) by 745 mmHg by using the vacuum pump 305. After this, the temperature was increased slowly to the boiling point of the PDCP. PDCP vapor vaporized at the boiling point moved to the storing vessel 304 while being condensed by passing through the distillation column 302 and the cooler 303. After the PDCP was separated to the storing vessel, the completion time of the separating of the PDCP was decided when the temperature change was sensed by the temperature sensor 308. That is, in case that the PDCP vapor is generated no more the temperature near the temperature sensor is decreased, accordingly, whether the separating of the PDCP is completed can be decided.

After the separating of the PDCP, the DPCP was separated by using the same method by increasing the temperature to the boiling point of the DPCP.

### Exemplary Embodiment 3

### Composing of DPBAP (Diphenylbutylaminophosphate)

265 kg of the DPCP produced in the exemplary embodiment 2 was inputted to a second composing reaction tank 401, and stirred while dropping 85 kg of butylamine stored in a separate storing tank 403. A stirrer 404 for mixing the butylamine and DPCP is equipped in the second composing reaction vessel 401, and a cooler 402 maintaining the temperature of the reaction tack at a low temperature is installed to the lower part of the second composing reaction tank 401.

The butylamine is dropped from the upper part of the second composing reaction tank 401, and vaporized by the reaction heat generated from the reaction of the butylamine and DPCP, and this is condensed by a cooler 405 installed to the upper part of the second composing reaction tank 401. The cooler is a dual cooler configured with a first cooler and a second cooler.

The temperature of the second composing reaction tank was maintained below a temperature of 30° C. during the composing reaction process, the DPBAP (Diphenylbutylaminophosphate) was composed by reacting the DPCP and butylamine. The composed DPBAP was matured below a temperature of 70° C. during 6 hours. During the maturing process, operation of the cooler was stopped temporarily and a heating state (about 70° C.) was maintained by operating a boiler connected to the same line with the cooler.

### Exemplary Embodiment 4

### Neutralizing and Filtering of DPBAP

The compounds of the exemplary embodiment 3 have the high acidity because contain chlorine gas besides the DPBAP, and the compounds were neutralized to pH 7 while dropping 25% NaOH (aqueous) in order to neutralize the acidity. At this, the temperature was maintained below a temperature of 70° C. H₂O produced due to the butylamine which is not reacted and the neutralizing reaction was removed through a vacuum dry process, NaCl was removed by adding the same volume of ethanol (or methanol) with the DPBAP. In case that the water remains in the resultant product the ethanol or methanol becomes turbid, accordingly, whether the water is removed completely is checked with the naked eye. The solvent like ethanol was removed by desolventizing process later.

When removing of the NaCl, ethanol was added and stirred. Then, the resultant product was moved to a filtering vessel, first-filtered by using a filter cloth, and second-filtered by using a pressure filter. The purity of the final DPBAP was measured at 93.88% (measuring test on purity: by the Advanced Analysis Center of the Korea Institute of Science and Technology).

### Exemplary Embodiment 5

### Test on Toxicity of DPBAP

A test on the toxicity of the DPBAP in accordance with the method of the present invention was performed (by the Korea Research Institute of Chemical Technology). After treating the DPBAP to CHO cells, chromosomal abnormality was measured. Consequently, the increasing of the chromosomal abnormality was not observed in all of DPBAP treatment groups regardless of application of metabolic activation system. Merely, minority of polyploid and endoreduplication was observed in the highest-concentration groups (treated during 24 hours). However, in the CHO cells, it was known that the polyploid and endoreduplication can be generally observed due to the over-proliferation, or other causes (Scott et al., 1990). In this test, the endoreduplication was observed in the groups treated with the highest-concentration of the test material, and considering that about 50% of cells are dead in this concentration, no toxicity were observed on the DPBAP in accordance with the method of the present invention.

The drawings and detailed description are only examples of the present invention, serve only for describing the present invention and by no means limit or restrict the spirit and scope of the present invention. Accordingly, it will be appreciated by any person of ordinary skill in the art that a large number of modifications, permutations and additions are possible within the principles and spirit of the invention, the scope of which shall be defined by the appended claims and their equivalents.

1. A method for preparing an aromatic phosphate ester-based compound comprising the steps of:
(a) reacting a compound expressed by a chemical formula 1 (i) and a C₆₋₁₀ aryl compound substituted with hydroxy or C₁₋₆ alkoxy, or a C₆₋₂₀ arylalkyl compound substituted with hydroxy or C₁₋₆ alkoxy (ii), which are used as reaction materials by gradually heating to the temperature levels of 90-125° C., 125-180° C., 180-210° C. and 210-240° C.;
(b) separating an aromatic phosphate ester-based compound from the resultant product of the step (a) under the condition of a pressure of 0.01 mmHg-50 mmHg and a temperature of 50° C.-300° C. by using fractional distillation; and
(c) reacting the aromatic phosphate ester-based compound separated in the step (b) (i) and C₁₋₁₀ alcohol or a nitrogen compound (ii) at a temperature of 10-70° C.; 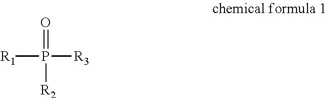
wherein R₁, R₂ and R₃ of the chemical formula 1 are, respectively and independently, halo (i), C₆₋₁₀ aryl substituted with hydroxy or C₁₋₆ alkoxy (ii), or C₆₋₂₀ arylalkyl substituted with hydroxy or C₁₋₆ alkoxy (iii); and one or more of R₁, R₂ and R₃ is halo.

2. The method of claim 1, wherein R₁, R₂ and R₃ of the chemical formula 1 are, respectively and independently, halo (i), C₆ aryl substituted with hydroxy or C₁₋₃ alkoxy (ii), or C₆₋₁₀ arylalkyl substituted with hydroxy or C₁₋₃ alkoxy (iii).

3. The method of claim 1,
wherein the reaction of the step (a) brings a refluxing circulation of the resultant products or the reaction materials of the step (a) at each temperature level.

4. The method of claim 1,
wherein the step (c) further comprises the step of neutralizing the resultant product of the step (c) after the step (c).

5. The method of claim 4, wherein the step of neutralizing the resultant product of the step (c) further comprises the step of removing the by-product of the neutralizing step, and the removing step is performed by adding ethanol, methanol, or toluene.

6. The method of claim 1, the nitrogen compound of the step (c) is selected from the group of propylamine, butylamine, and hexamine.

7. The method of claim 1, the reaction of the step (c) is performed at a temperature of 20-40° C.

8. The method of claim 1,
further comprising the step of cooling heat generated during the reaction of the compounds in the step (a) to the step (c) or the fractional distillation.

9. The method of claim 8, wherein the step of cooling the heat generated during the reaction of the compounds or the fractional distillation of the step (a) to the step (c) is performed by using a dual cooling system including the steps of condensing compound vapor vaporized during the step (a) to the step (c) using heating medium oil or silicone oil as cooling fluid (i), and cooling the heating medium oil heated in the step (i) using water as cooling fluid (ii).

10. The method of claim 1, wherein the aromatic phosphate ester-based compound is selected from the groups of compounds expressed by a chemical formula 2 to a chemical formula 5:

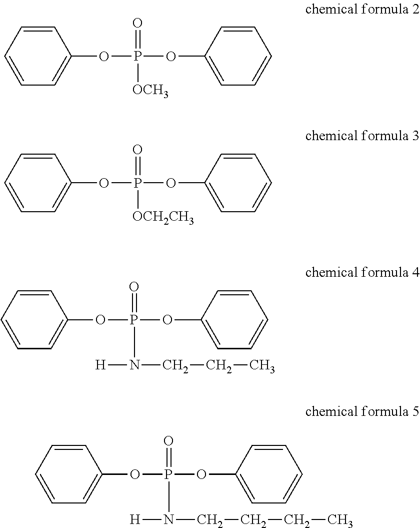 [SMILES: COP(=O)(Oc1ccccc1)Oc1ccccc1 ; CCOP(=O)(Oc1ccccc1)Oc1ccccc1 ; CCCNP(=O)(Oc1ccccc1)Oc1ccccc1 ; CCCCNP(=O)(Oc1ccccc1)Oc1ccccc1]

11. A dual cooling system comprising the steps of:
(a) a first step for cooling materials to be cooled using heating medium oil as cooling fluid; and
(b) a second step for cooling the heating medium oil heated in the first cooling step using water as cooling fluid.

12. The dual cooling system of claim 11, wherein the materials to be cooled of the step (a) have high reactivity with water.

13. A method for composing a compound comprising the steps of:
(a) reacting two or more of reaction materials by heating;
(b) refluxing compound vapor that the reaction material and the resultant product of the step (a) is vaporized by condensing; and
(c) cooling heat generated during the step (a) and the step (b), wherein the step (c) is performed by using a dual cooling system including the steps of condensing compound vapor vaporized during the step (a) to the step (b) using heating medium oil as cooling fluid (i), and cooling the heating medium oil heated in the step (i) using water as cooling fluid (ii).

14. The method of claim 13, wherein the composing method is performed in a reacting vessel having an inner wall coated with glass or carbon.

15. A method for fractional distillation comprising the steps of:
(a) depressurizing pressure of a reaction system containing a resultant product including two or more of compounds and chlorine gas by using a vacuum pump;
(b) collecting the chlorine gas included in the resultant product from the depressurizing process of the step (a);
(c) heating the two or more of compounds included in the resultant product of the step (a) from which the chlorine gas is removed; and
(d) condensing compound vapor vaporized from the compounds of the step (c) by cooling.

16. The method of claim 15, wherein the fractional distillation method is performed in a distiller having an inner wall coated with glass or carbon.

17. A low-temperature method for composing an aromatic phosphate ester-based compound having one of a chemical formula 2 to a chemical formula 5 comprising the steps of:
(a) reacting phenyldichlorophosphate, diphenylchlorophosphate, or an aromatic phosphate ester-based compound of phenyldichlorophosphate and diphenylchlorophosphate (i) and a C₁₋₁₀ alcohol or nitrogen compound (ii), which are used as reaction materials by stirring at a temperature of 10-70° C.;
(b) reacting while maintaining the temperature of 10-70° C. by cooling heat generated from the reaction of the step (a);
(c) neutralizing the compound having one of the chemical formula 2 to the chemical formula 5 which is the resultant product of the step (b); and
(d) removing H₂O and salts produced by the neutralizing reaction of the step (c).

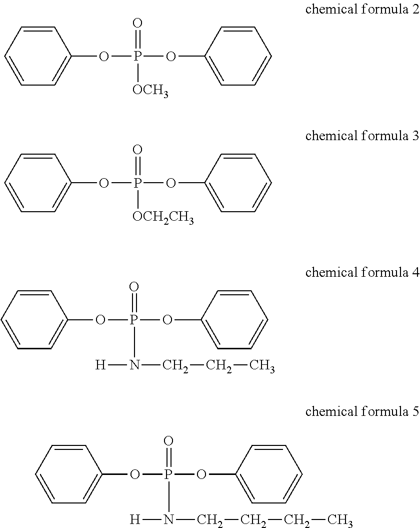 [SMILES: COP(=O)(Oc1ccccc1)Oc1ccccc1 ; CCOP(=O)(Oc1ccccc1)Oc1ccccc1 ; CCCNP(=O)(Oc1ccccc1)Oc1ccccc1 ; CCCCNP(=O)(Oc1ccccc1)Oc1ccccc1]

18. A dual cooling apparatus comprising:
(a) a first cooling device using heating medium oil as cooling fluid, formed with lines through which materials to be cooled are passable in the cooling device, and cooling the temperature by passing the materials to be cooled through the lines; and
(b) a second cooling device using water as cooling fluid, and cooling the temperature of the heating medium oil heated in the first cooling device by passing the heated heating medium oil in the first cooling device through the inner space of the cooling device.

19. The dual cooling apparatus of claim 18, wherein the materials to be cooled have high reactivity with water.

20. An apparatus for composing a compound comprising:
(a) a reacting vessel containing two or more of reaction materials and in which a chemical reaction of the reaction materials is performed;
(b) a refluxing circulator installed to the upper part of the reacting vessel and refluxing compound vapor vaporized in the reacting vessel to the reacting vessel by condensing; and
(c) a dual cooler, as a cooler for cooling heat generated in the refluxing circulator installed to the reacting vessel, including a first cooler 203A using heating medium oil as cooling fluid, installed to the outer part of the refluxing circulator, and condensing the compound vapor vaporized in the reacting vessel (i), and a second cooler using water as cooling fluid, formed with a plurality of lines through which the cooling fluid of the first cooler is passable in the cooler, and cooling the heated heating medium oil of the first cooler.

21. The apparatus of claim 20, wherein the inner walls of the reacting vessel and the refluxing circulator are coated with glass or carbon.

22. A fractional distillation apparatus comprising:
(a) a distiller containing a resultant product including two or more of compounds and chlorine gas;
(b) a distillation column installed to the upper part of the distiller and through which compound vapor vaporized in the distiller passes;
(c) a cooler for condensing the compound vapor vaporized in the distiller;
(d) a storing vessel storing a compound condensed in the step (c);
(e) a vacuum pump depressurizing pressure in the distiller and for collecting the chlorine gas in the distiller; and
(f) a storing vessel storing the chlorine gas collected by the vacuum pump.

23. The apparatus of claim 22, wherein the inner walls of the distiller and the distillation column are coated with glass or carbon.

24. The apparatus of claim 22, further comprising temperature sensors installed to the lower part of the distiller, the connecting portion of the distiller and distillation column, and the upper part of the distillation column in order to measure temperature of the compound contained in the distiller or the compound vapor vaporized in the distiller.

25. A low-temperature apparatus for composing a compound comprising:
(a) a reacting vessel containing two or more of reaction materials and in which a chemical reaction of the reaction materials is performed;
(b) a dual cooler, as a dual cooler for cooling heat generated in the reacting vessel, installed to the lower part or the side part of the reacting vessel and including a first cooler using heating medium oil as cooling fluid, installed to the outer part of the reacting vessel, and cooling heat generated in the reacting vessel (i), and a second cooler using water as cooling fluid, formed with a plurality of lines through which the cooling fluid of the first cooler is passable in the cooler, and cooling the heated heating medium oil of the first cooler.
(c) a storing vessel installed to the upper part or the side part of the reacting vessel, and containing a compound for neutralizing the resultant product contained in the reacting vessel or additional reaction materials reacting with the reaction materials in the reacting vessel.

26. The apparatus of claim 25, further comprising a stirrer stirring the reaction materials in the reacting vessel.
